(19) United States
(12) Patent Application Publication
(10) Pub. No.: US 2012/0276892 A1
(43) Pub. Date: Nov. 1, 2012

(54) HUB BASE STATION

(75) Inventor: Jie LIN, Hampshire (GB)

(73) Assignee: Huawei Device Co., LTD., Shenzhen (CN)

(21) Appl. No.: 13/453,638

(22) Filed: Apr. 23, 2012

Related U.S. Application Data
(63) Continuation of application No. PCT/CN2009/074724, filed on Oct. 30, 2009.

(51) Int. Cl. H04W 40/06; H04W 88/08

(52) U.S. Cl. 455/422.1; 455/562.1

(57) ABSTRACT

The invention relates to a hub base station being capable of communicating with a plurality of remote network entities over a cellular communication network. The hub base station comprises a transmitter being configured to transmit a plurality of distinct radio frequency beams towards a plurality of distinct directions for backhaul communications.

### CROSS-REFERENCE TO RELATED APPLICATIONS

This application is a continuation of International Application No. PCT/CN2009/074724, filed on Oct. 30, 2009, entitled “Hub base station”, which is hereby incorporated herein by reference.

### BACKGROUND OF THE INVENTION

The present invention relates to backhaul communications.

Building, expanding and upgrading radio communication systems, such as a 2^{nd} generation system, e.g. a Global System for Mobile Communications (GSM) or a 3^{rd} Generation Partnership Project (3GPP) system, e.g. a Universal Mobile Telecommunications System (UMTS) or Long Term Evolution (LTE), involves enormous costs when good coverage should be achieved. In order to achieve sufficient coverage over the whole geographical area being covered by the radio communication system, a very large number of base stations have to be installed and interconnected via communication links in a communication network. Additionally, a rapid advance of wireless technology and ever increasing popularity with mobile Internet has created a need to expand mobile broadband services (MBB) to rural areas. A key enabler to cost effective provision of such services is low cost microwave backhaul.

Traditional microwave solutions perform two basic functions sequentially, i.e. on a hop by hop basis by traffic aggregation and a data transmission. A conventional backhaul approach operates on a hop by hop basis and, in each hop, inlet traffic is aggregated from each branch. Subsequently, the combined data streams are transmitted to the next hop. For a star like network topology, typical microwave backhaul will require multiple hops before reaching the centre base station.

Using a cellular communication approach to backhaul can also be traced back to fixed wireless local loop. In this regard, newly available LTE spectrum in 2.6G and the cell throughput for LTE MIMO (Multiple Input Multiple Output) provide sufficient communication resources for e.g. self-backhaul solutions, such as inband self-backhaul and out-of-band self-backhaul based on Time Division Duplex (TDD). The inband self-backhaul solution shares the same spectrum with normal cellular communication systems. The backhaul part of the system “steals” unused resource units from the cellular air interface for backhauling traffic to the next hop. The out of band self-backhaul based on TDD uses a TDD spectrum for backhauling eNodeB traffic created via a Frequency Division Duplex (FDD) air interface used in normal cellular communications.

### SUMMARY OF THE INVENTION

A goal to be achieved by the present invention is to provide an efficient backhaul communication concept, in particular a self-backhaul concept, especially for rural areas.

The invention is based on the finding that an efficient backhaul communication concept may be provided if a cellular communication system is enabled to perform traffic aggregation and data stream transmission concurrently for the purpose of backhaul transmission, which may reduce the backhaul transmission equipment costs. This may be achieved by using directional radio frequency beams for backhaul transmissions in particular in rural communication networks.

According to an aspect, a central or hub base station is provided which is capable of communicating with a plurality of remote network entities, e.g. remote base stations, over a cellular communication network for backhaul communications. The hub base station may be a normal base station supporting cellular communications of the plurality of remote network entities over a communication network according to any known wireless communication technology, e.g. LTE or UMTS. In addition, the hub base station may comprise additional features referred to in the following for supporting efficient backhaul transmissions.

The hub base station comprises a transmitter which is configured to transmit a plurality of distinct radio frequency beams towards a plurality of distinct directions for communicating with the plurality of remote network entities. By way of example, the remote network entities may be arranged within a sectored communication cell of a communication network, e.g. a rural communication network, wherein the hub base station may be arranged at a center thereof as a hub base station. In order to enable backhaul transmissions, the hub base station may transmit a single transmission beam to each remote, dedicated network entity.

According to an implementation, the transmitter may be configured to transmit only one transmission beam to a dedicated remote network entity. In other words, the transmitter may transmit a single transmission beam towards a direction to which a dedicated remote network entity is arranged in the network.

According to an implementation, the hub or central base station or the transmitter may further comprise a beam former being configured to form a plurality of distinct radio frequency beams. By way of example, the beam former may be configured to sequentially form the plurality of distinct transmission beams so that, at a certain time instant, only one transmission beam is formed. However, the plurality of distinct beams may simultaneously be formed and transmitted.

According to an implementation, the hub base station or the transmitter may comprise a plurality of antennas being arranged to form an antenna array. The hub base station may further comprise a steerer for steering the antenna array to transmit a transmission beam towards a certain direction, or to receive a reception beam from a certain direction. According to an implementation, the hub base station may also comprise a receiver for receiving a radio frequency beam from a remote network entity being arranged to transmit a transmission radio frequency beam.

According to an implementation, the hub base station or the transmitter may comprise a vertically focusing antenna for transmitting or receiving distinct radio frequency beams. The vertically focusing antenna may be radar-like which may be formed to achieve a gain of e.g. 25 dBi to maintain coverage within a sector which is covered by the antenna.

According to an implementation, the hub base station or the transmitter may comprise an antenna with a plurality of sectors for transmitting or receiving distinct radio frequency beams. By way of example, the sectorization of the antenna may correspond to normal antenna sectorizations.

According to an implementation, the transmitter is configured to transmit at least six distinct transmission beams towards different directions. Thus, the transmitter may serve at least six distinct remote network entities arranged at different locations of the network cell.

According to an implementation, the transmitter is configured to transmit the plurality of distinct radio frequency beams using a normal cellular communication spectrum, in particular one of:

the LTE communication spectrum,

the UMTS communication spectrum, or

the GSM communication spectrum, or

the 800 MHz communication spectrum, or

the 900 MHz communication spectrum, or

the 1800 MHz communication spectrum, or

the 2.1 GHz communication spectrum, or

the 2.6 GHz communication spectrum.

Thus, the hub base station may use a normal cellular communication spectrum that usually is not used in rural areas, for the purpose of backhaul in particular in rural areas.

According to a further aspect, a remote network entity being configured to communicate with the hub base station according to the invention is provided. The remote network entity comprises a transmitter for transmitting a radio frequency beam towards the hub base station for backhaul communications.

According to an implementation, the remote network entity may comprise an antenna being configured to transmit the radio frequency beam towards the certain direction or for receiving a radio frequency beam from the certain direction. By way of example, the antenna may be a dish antenna used for directional communications.

According to an implementation, the remote network entity may be configured to transmit the radio frequency beam by reversing transmission and reception frequencies used in the basestion of cellular communication technologies, in particular used in the LTE or GSM or UMTS technology. Thus, reversing Tx/Rx frequencies of the remote network entity, e.g. a remote RF unit, of a normal LTE base station enables the remote network entity to act as the terminal end of a backhaul link.

According to an implementation, the remote network entity may be a LTE or a UMTS or a GSM base station.

According to a further aspect, a rural communication system comprising the inventive hub base station and the inventive remote network entity is provided. Preferably, the rural communication system comprises the hub base station and at least six remote network entities.

According to a further aspect, a backhaul communication method for communicating with a plurality of remote network entities over a cellular communication network is provided. The backhaul communication method comprises transmitting a plurality of distinct radio frequency beams towards a plurality of distinct directions for communicating with the plurality of remote network entities.

According to a further aspect, a backhaul communication method for communicating with a hub base station is provided. The backhaul communication method comprises transmitting a radio frequency beam towards the hub base station for backhaul communications.

### BRIEF DESCRIPTION OF THE DRAWINGS

Further embodiments of the invention will be described with respect to the following figures, in which:

FIG. 1 shows a hub base station;

FIG. 2 shows a remote network entity;

FIG. 3 shows a remote network entity;

FIG. 4 shows an antenna;

FIG. 5 shows a 2G evolution scenario;

FIG. 6 shows a network configuration;

FIG. 7 shows a network configuration; and

FIG. 8 shows a communication system.

### DETAILED DESCRIPTION OF EMBODIMENTS OF THE INVENTION

Before embodiments of the invention are described in detail, it is to be understood that this invention is not limited to the particular component parts of the devices described or steps of the methods described as such devices and methods may vary. It is also to be understood that the terminology used herein is for purposes of describing particular embodiments only, and is not intended to be limiting. It must be noted that, as used in the specification and the appended claims, the singular forms “a,” “an” and “the” include singular and/or plural referents unless the context clearly dictates otherwise.

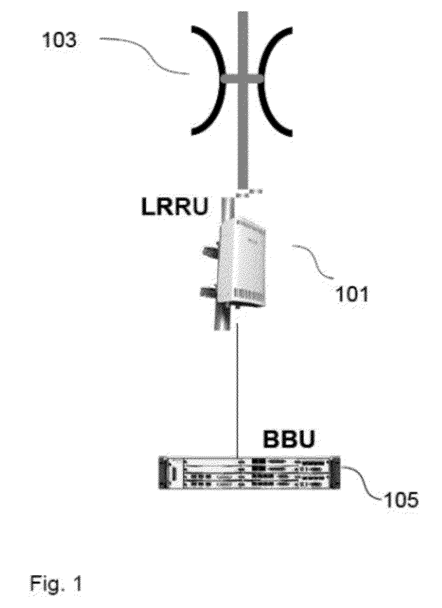

FIG. 1 shows a hub base station comprising a transmitter with a remote radio unit (RRU) 101, e.g. a LRRU, and an antenna 103 coupled to the remote radio unit 101. The hub base station may further comprise a base band unit (BBU) 105 which is coupled to the RRU 101.

The hub base station depicted in FIG. 1 may be a standard LTE FDD eNodeB (LTE: Long Term Evolution; FDD: Frequency Division Duplex) which may be used for communicating with remote network entities, e.g. remote sites. Thus, the antenna 103 is additionally provided for backhaul transmissions.

According to some implementations, the antenna 103 may be a radar-like antenna which focuses vertically to e.g. eliminate unnecessary radiation at the ground level and to improve the antenna gain. Optionally, the antenna 103 may be a sectored antenna, e.g. a sectored dish-like antenna with three sectors, wherein the normal antenna sectorization may be maintained. In particular, a sectorization using e.g. three sectors in the horizontal direction may support an efficient P2MP (Point to Multipoint) backhaul transmission since one sector may serve multiple remote network entities, e.g. base transceiver stations (BTS). In this way, the antenna 103 may achieve a gain of approximately 25 dB and yet maintain a coverage within a network sector it covers.

According to some implementations, beam forming methods may be employed in order to create different beams focusing towards different directions, e.g. focusing on different remote base stations communicating with the hub base station. By way of example, the RRU 101 may form a four transmitters and four receivers unit (4T4R). In this case, the antenna 103 may create two beams focusing on individual remote network entities. Since the remote network entities are usually not moving within the network, it may be sufficient to steer the beam using the RRU 101 e.g. once during the installation phase.

According to some implementations, the antenna 103 may comprise a plurality of sub-antennas forming an antenna array which may be steered by the RRU 101. According to some implementations, the RRU 101 may be a standard LRRU with 20 MHz operating and with an e.g. 2.6 GHz.

According to some implementations, the transmitter may be a 2×40 W transmitter being arranged to support the 2T2R MIMO approach (2T2R: two transmitters two receivers; MIMO: Multiple Input Multiple Output). The base band unit 105 may be configured to perform base band communications using e.g. LBBP and/or LMPT cards (controller and transmission cards).

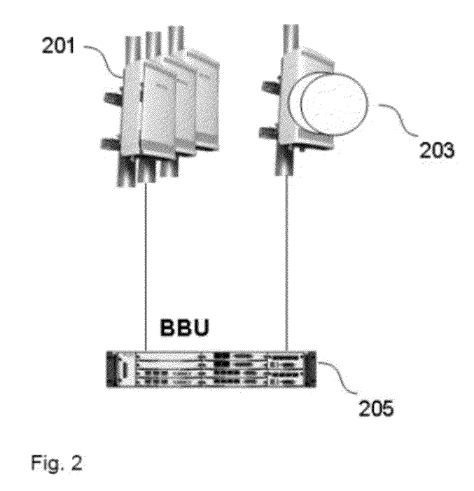

FIG. 2 shows an embodiment of a remote network entity which is capable of communicating using directed radio frequency beams with the hub base station mentioned above. The remote network entity may comprise a RRU 201, e.g. a TX/RX frequency reversed RRU, e.g. according to the GSM/UMTS or GSM/L900technology. The RRU 201 may be a 1T2R unit (1T2R: one transmitter two receivers) with an integrated LTE terminal part or with a terminal which may be configured new software to run on one of the LBBP cards. The remote network entity may further comprise an antenna 203, which may be a high gain dish antenna with a 3 to 5 degree beam and a gain of approximately 30 dBi.

The RRU 201 and the antenna 203 may be coupled to a base band unit 205. In this regard, a standard data card may be used as the base band unit 205 as the remote network entity may form user equipment (UE) in the self-backhaul solution.

The remote network entity depicted in FIG. 2 may operate according to the 2.6 GHz LTE technology with e.g. 10 MHz operating bandwidth. Furthermore, the remote network entity may support 30 Mbps in the downlink direction and, by way of example, more than 2 Mbps in the reverse link.

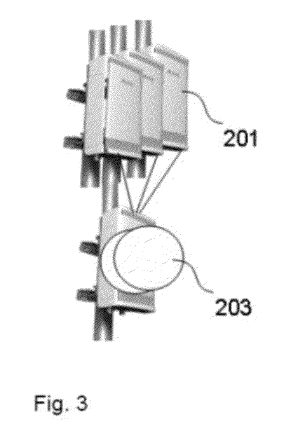

The remote network entity shown in FIG. 2 forms a stand-alone solution. According to the embodiment shown in FIG. 3, the remote network entity may form an integrated solution, wherein the RRU 201 may communicate with the antenna 203 via CPRI (Common Public Radio Interface). The RRU 201 may be a low cost RRU according to the 1T2R approach with reversed TX/RX. Furthermore, an integrated LTE terminal may be provided with the RRU 201. According to some implementations, the remote network entity shown in FIG. 3 may operate according to the GSM/UMTS or GSM/L900 technologies and may be implemented to form a base station transceiver (BTS).

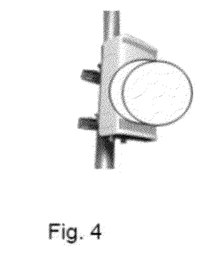

FIG. 4 depicts a dish antenna which may be used by the hub base station or by the remote network entity for beam-based, directional communications.

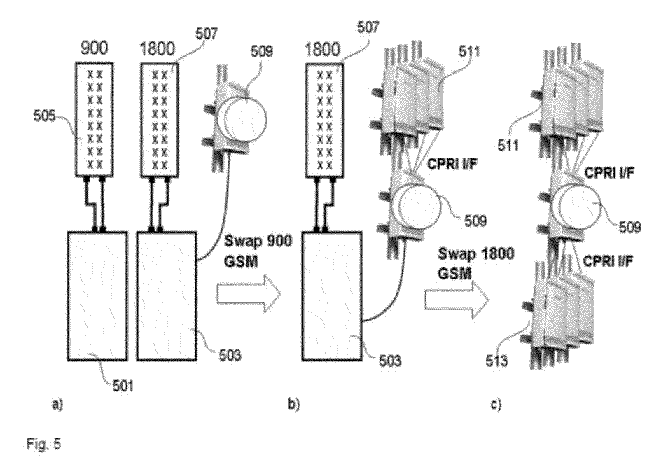

FIGS. 5A to 5C show different embodiments of a hub base station. With reference to FIG. 5A, the hub base station may comprise base band units 501, 503 for which are respectively coupled to transmitters 505 and 507 which may operate in the 900 MHz and 1800 MHz bands. The hub base station may thus be used for cellular communications e.g. according to the GSM or LTE standard. In addition, in order to enable direct beam transmissions, an antenna 509 is provided which is capable of transmitting a radio frequency beam towards a remote network entity.

The hub base station shown in FIG. 5A may be further developed by swapping the 900 GSM technology which results in the hub base station shown in FIG. 5B comprising a RRU 511 steering the antenna 509. A further evolution of the hub base station by swapping the 1800 GSM technology may result in a hub base station shown in FIG. 5C comprising the RRU 511 operating according to the 900 GSM technology, and, additionally, a further RRU 513 operating according to the 1800 GSM technology. The RRU 511 and the RRU 513 may respectively excite the antenna 509 to enable backhaul communications using radio frequency beams. As shown in FIGS. 5A to 5C, the legacy microwave backhaul technology may be developed by swapping the 900 GSM technology with RRU/DBS without affecting other legacy 2G units. However, all units may be swapped with integrated RRU/DBS.

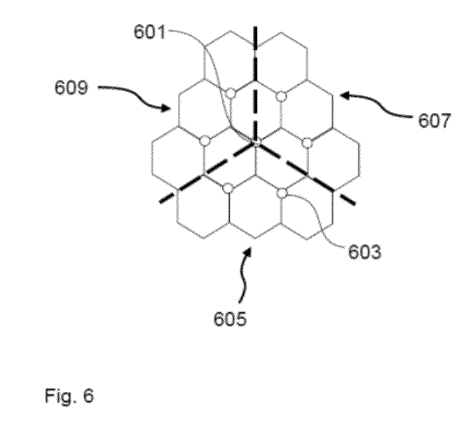

FIG. 6 shows a network configuration comprising a hub base station 601 and a plurality of remote network entities 603, e.g. six remote network entities. The hub base station 601 may be arranged to support cellular communications in a cellular communication network wherein, additionally, backhaul transmission according to the principles described herein is supported.

The hub base station 601 may form a hub side BTS, wherein a standard three sectored configuration at the hub base station side may be used with three sectors 605, 607 and 609. Each sector 605 to 609 may serve to remote network entities 603, e.g. BTSs. Each remote network entity 603 may be equipped with a high gain antenna, e.g. with a dish antenna, mounted on top of a tower pointing at the central side where the hub base station 601 is arranged. Correspondingly, the hub base station 601 may comprise a transmitter being capable of transmitting a distinct radio frequency beam to each remote network entity 603.

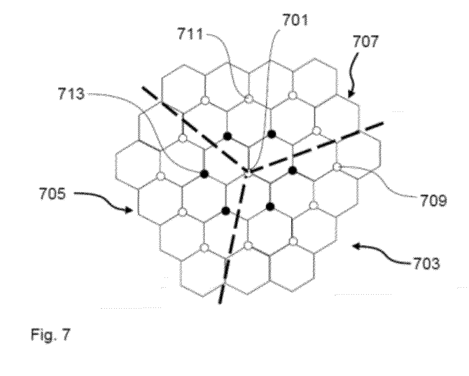

FIG. 7 shows another embodiment of a network configuration comprising a hub base station 701 arranged at a central side of the communication cell, wherein a three sectored configuration at the central side may again be provided with the sectors 703, 705 and 707. As depicted in FIG. 7, each sector 703 to 707 may serve six remote network entities 709, e.g. BTSs, which may be arranged to form a first ring 711 of remote network entities depicted by white dots and a second ring 713 of remote network entities depicted by black dots. Both rings 711 and 713 enclose the hub base station 701 which may also be used for normal cellular communications.

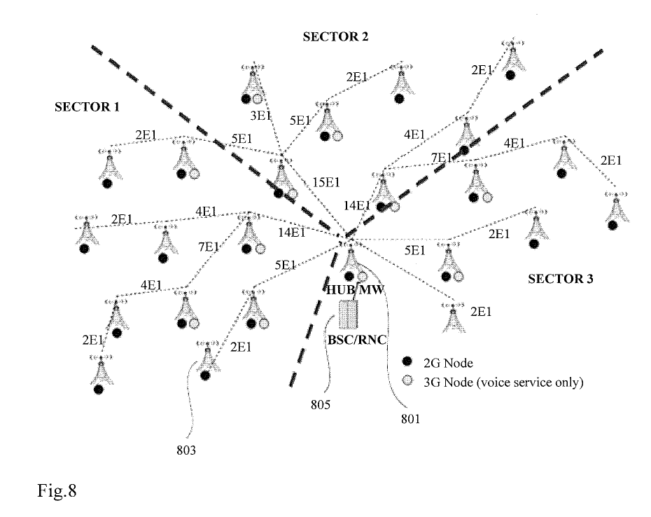

FIG. 8 shows a communication network comprising a centrally arranged hub base station 801 forming e.g. a hub microwave base station for communicating with a plurality of remote network entities 803 forming e.g. 2G or 3G nodes, e.g. for voice services. The hub base station 801 may also form a 2G or a 3G node which may be controlled by a control node 805, e.g. a BSC or RNC.

As depicted in FIG. 8, three sectors are used, wherein in each sector a plurality of remote network entity 103 is arranged. As shown in FIG. 8, by way of example, all together 23 remote network entities 803, e.g. remote base sides, and one centrally arranged hub base station 801 simultaneously forming a hub side are present. For example, sector 1 may comprise ten base sites, associated with a total throughput of 40 Mbps, sector 2 may be associated with seven base sites with a total throughput of 34 Mbps, and sector 3 may comprise six base sites with a total throughput of 28 Mbps. Based on a conventional start topology, sector 1 may comprise 20E1s, sector 2 may comprise 17E1s and sector 3 may comprise 14E1s. According to the inventive out of band self-backhaul approach, only one haul is needed, so that according to some implementations, a delay performance of the backhaul link may be improved since the number of hopes is reduced. Furthermore, cost savings can be achieved.

According to some implementations, the 2.6G FDD technology may be used for self-backhaul of standard cellular communication systems e.g. 800 MHz LTE, 900 MHz/1800 MHz GSM, 2.1G UMTS, etc. This is particularly useful as 2.6 GHz spectrum is expected to be mainly used for urban communication purpose and nobody will be using it for rural communications. This means that the spectrum is free for low cost backhaul in rural areas.

According to some implementations, a RRU at the remote sites, i.e. network entities, with reversed Tx/Rx frequencies may be used. According to some implementations, a datacard chipset for the baseband processing at the remote site may be used. According to some implementations, the baseband processing can also be implemented in software running on a shared baseband equipment with the remote site BBU. According to some implementations, a standard microwave antenna/dish for self-backhaul solution based on 2.6G LTE FDD may be used. According to some implementations, a standard LTE eNodeB for self-backhaul at the remote site may be used. According to some implementations, a radar-like antenna may be used at the hub site, i.e. at the hub base station which focuses vertically but maintain normal antenna sectorization. According to some implementations, a beam forming technique may be used to create separate beams focusing on each individual remote site. According to some implementations, a multiple self-backhaul configuration created via incorporating multiple tiers of remote base sites may be used.

The beam-based, directional backhaul concept enables making use of otherwise unusable frequency in rural areas for the purpose of rural MBB backhaul as 2.6G FDD is widely considered not usable for rural cellular communications. According to some implementations, a microwave backhaul transmission efficiency may be improved by leveraging the point to multi-point nature of cellular communication as oppose to the traditional hop by hop microwave approach. According to some implementations, the same equipment as LTE eRAN (Radio Access Network) at the hub eNodeB site may be used, which may help to reduce the product cost as there is almost zero product development required for this solution. According to some implementations, on the remote site, it a Tx/Rx reversed LTE RRU as the radio unit for the backhaul transmission and a standard

LTE datacard as the baseband may be used. According to some implementations, a reuse of mainstream cellular communication equipment may be maximized which may minimize the product development effort.

The particular combinations of elements and features in the above detailed embodiments are exemplary only; the interchanging and substitution of these embodiments with other embodiments disclosed herein are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

1. A hub base station being capable of communicating with a plurality of remote network entities over a cellular communication network, the hub base station comprising:
a transmitter being configured to transmit a plurality of distinct radio frequency beams towards a plurality of distinct directions for backhaul communications.

2. The hub base station according to claim 1, wherein the transmitter is configured to transmit a distinct transmission beam to each remote network entity.

3. The hub base station according to claim 1, the transmitter comprising a beam former being configured to form the plurality of distinct radio frequency beams.

4. The hub base station according to claim 1, the transmitter comprising a plurality of antennas being arranged to form an output antenna array, and a steerer for steering the antenna array to transmit a transmission beam towards a certain direction, or to receive a reception beam from a certain direction.

5. The hub base station according to claim 1, wherein the transmitter comprises a vertically focusing antenna for transmitting or receiving distinct radio frequency beams.

6. The hub base station according to claim 1, wherein the transmitter comprises an antenna with a plurality of sectors for transmitting or receiving distinct radio frequency beams.

7. The hub base station according to claim 1, wherein the transmitter is configured to transmit at least 6 distinct transmission beams towards different directions.

8. The hub base station according to claim 1, wherein the transmitter is configured to transmit the plurality of distinct radio frequency beams using a normal cellular communication spectrum, in particular one of:
the LTE communication spectrum,
the UMTS communication spectrum, or
the GSM communication spectrum, or
the 800 MHz communication spectrum, or
the 900 MHz communication spectrum, or
the 1800 MHz communication spectrum, or
the 2.1 GHz communication spectrum, or
the 2.6 GHz communication spectrum.

9. A remote network entity being configured to communicate with the hub base station according to claim 1, the remote network entity comprising a transmitter for transmitting a radio frequency beam towards the hub base station for backhaul communications.

10. The remote network entity according to claim 9, further comprising an antenna being configured to transmit the radio frequency beam towards a certain direction or for receiving a radio frequency beam from the certain direction.

11. The remote network entity according to claim 9, being configured to transmit the radio frequency beam by reversing transmission and reception frequencies of a basestation radio to act as a terminal end of a backhaul link.

12. The remote network entity according to the claim 9, being a LTE or a UMTS or a GSM base station.

13. A rural communication system, comprising the hub base station being capable of communicating with a plurality of remote network entities over a cellular communication network, the hub base station comprising:
a transmitter being configured to transmit a plurality of distinct radio frequency beams towards a plurality of distinct directions for backhaul communications, and at least one remote network entity according to claim 9.

14. A rural communication system, comprising the hub base station according to claim 1, and at least one remote network entity being configured to communicate with the hub base station according to claim 1, the remote network entity comprising a transmitter for transmitting a radio frequency beam towards the hub base station for backhaul communications.

15. A communication method for communicating with a plurality of remote network entities over a cellular communication network, the communication method comprising:
transmitting a plurality of distinct radio frequency beams towards a plurality of distinct directions for backhaul communications.

16. A communication method for communicating with a hub base station according to the claim 1, the backhaul communication method comprising transmitting a radio frequency beam towards the hub base station for backhaul communications.
